(19) United States
(12) Patent Application Publication
(10) Pub. No.: US 2020/0349264 A1
(43) Pub. Date: Nov. 5, 2020

(54) DATA DECRYPTION METHOD AND APPARATUS, AND ELECTRONIC DEVICE

(71) Applicant: AUTEL INTELLIGENT TECHNOLOGY CORP., LTD., Shenzhen (CN)

(72) Inventors: Yun JIANG, Shenzhen (CN); Songsong Qu, Shenzhen (CN)

(21) Appl. No.: 16/930,563

(22) Filed: Jul. 16, 2020

Related U.S. Application Data
(63) Continuation of application No. PCT/CN2019/070884, filed on Jan. 8, 2019.

(30) Foreign Application Priority Data
Jan. 16, 2018 (CN) 201810040090.5

(51) Int. Cl. G06F 21/60; H04L 9/08

(52) U.S. Cl. CPC G06F 21/602; H04L 9/0819

(57) ABSTRACT

The present invention relates to the field of data decryption technologies, and in particular, to a data decryption method and apparatus, and an electronic device. The method includes: obtaining, by a control module, a file of an encrypted application and encrypted control data; sending the obtained file of the encrypted application to an encryption module; and decrypting, by the encryption module, the encrypted control data to obtain decrypted control data. This implementation improves the difficulty and costs for decrypting data, and there will be no delay in the response and processing of other functions with high real-time requirements, thus ensuring smooth running of all functions.

This application is a continuation application of International Application No. PCT/CN2019/070884, filed on Jan. 8, 2019, which claims priority of Chinese Patent Application No. 201810040090.5, filed on Jan. 16, 2018, which is incorporated herein by reference in its entirety.

### BACKGROUND

### Technical Field

This application relates to the field of data decryption technologies, and in particular, to a data decryption method and apparatus, and an electronic device.

### Related Art

Currently, control data of a device is generally stored in a storage module of the device after being encrypted, and a control program is stored in a control module of the device. When the control module of the device needs to run the control data, the encrypted control data is read from the storage module, and the encrypted control data is decrypted by using the control program. After decrypted control data is obtained, the control module loads and runs the control data.

In a process of implementing embodiments of the present invention, the following problems exist in the related art. On the one hand, after the control program of the control module is cracked, a decryption algorithm of the data can be obtained. Therefore, data security is not high in the related art. On the other hand, when decrypting the control data, the control module needs a lot of time on computing and processing to decrypt the control data, causing a delay of the control module in the response and processing of other functions with high real-time requirements.

### SUMMARY

The present invention provides a data decryption method and apparatus, and an electronic device to resolve technical problems in the related art that: data security is not high and data is easy to be cracked, and the response and processing of other functions with high real-time requirements are delayed when the data is decrypted.

According to a first aspect of the embodiments of the present invention, a data decryption method is provided. The method includes:

obtaining, by a control module, a file of an encrypted application and encrypted control data;

sending the obtained file of the encrypted application to an encryption module; and

decrypting the encrypted control data by using the encryption module to obtain decrypted control data.

In some embodiments, the decrypting the encrypted control data by using the encryption module includes:

decrypting the file of the encrypted application by using the encryption module to obtain a decrypted application; and

decrypting the encrypted control data according to the decrypted application.

In some embodiments, the decrypting the encrypted control data according to the decrypted application includes:

sending, by the control module, the obtained encrypted control data to the encryption module; and

running the decrypted application by using the encryption module, to decrypt the encrypted control data, where the decrypted application includes a decryption algorithm corresponding to the encrypted control data.

In some embodiments, the obtaining decrypted control data includes: receiving, by the control module, the decrypted control data sent by the encryption module.

In some embodiments, the decrypting the encrypted control data according to the decrypted application includes:

running the decrypted application by using the encryption module to obtain a key corresponding to the control data;

receiving, by the control module, the key sent by the encryption module; and

decrypting, by the control module, the encrypted control data according to the key.

In some embodiments, the obtaining a file of an encrypted application and encrypted control data specifically includes:

obtaining, by the control module, the file of the encrypted application and the encrypted control data from a storage module, where the control module obtains, according to a current to-be-executed control function, a file of an encrypted application and encrypted control data corresponding to the control function.

According to a second aspect of the embodiments of the present invention, a data decryption method applied to an encryption module is provided. The method includes:

receiving, by the encryption module, a file of an encrypted application;

decrypting the file of the encrypted application to obtain and run a decrypted application; and

decrypting encrypted control data according to the decrypted application to obtain decrypted control data.

In some embodiments, the decrypting encrypted control data according to the decrypted application to obtain decrypted control data includes:

receiving, by the encryption module, the encrypted control data from a control module; and

decrypting the encrypted control data according to the decrypted application to obtain the decrypted control data, where the decrypted application includes a decryption algorithm corresponding to the encrypted control data.

In some embodiments, after the encryption module obtains the decrypted control data, the method further includes: sending the decrypted control data to the control module.

In some embodiments, the encrypted control data is read by the control module from a storage module and then sent to the encryption module.

In some embodiments, the decrypting encrypted control data according to the decrypted application to obtain decrypted control data includes:

running the decrypted application to obtain a key; and

sending the key to the control module so that the control module decrypts the encrypted control data according to the key.

In some embodiments, the file of the encrypted application is read by the control module from the storage module and then sent to the encryption module.

According to a third aspect of the embodiments of the present invention, a data decryption apparatus is provided. The apparatus includes:

a first obtaining module, configured to obtain a file of an encrypted application and encrypted control data;

a first sending module, configured to send the obtained file of the encrypted application to an encryption module; and

a first decryption module, configured to decrypt the encrypted control data by using the encryption module to obtain decrypted control data.

In some embodiments, the first decryption module includes:

a first decryption unit, configured to decrypt the file of the encrypted application by using the encryption module to obtain a decrypted application; and

a second decryption unit, configured to decrypt the encrypted control data according to the decrypted application to obtain the decrypted control data.

In some embodiments, the second decryption unit is specifically configured to:

send the obtained encrypted control data to the encryption module; and

run the decrypted application by using the encryption module, to decrypt the encrypted control data, where the decrypted application includes a decryption algorithm corresponding to the encrypted control data.

In some embodiments, the obtaining decrypted control data includes: receiving the decrypted control data sent by the encryption module.

In some embodiments, the second decryption unit is specifically configured to:

run the decrypted application by using the encryption module to obtain a key corresponding to the control data;

receive the key sent by the encryption module; and

decrypt the encrypted control data according to the key.

In some embodiments, the first obtaining module is specifically configured to:

obtain the file of the encrypted application and the encrypted control data from a storage module, where the first obtaining module obtains, according to a current to-be-executed control function, a file of an encrypted application and encrypted control data corresponding to the control function.

According to a fourth aspect of the embodiments of the present invention, a data decryption apparatus applied to an encryption module is provided. The apparatus includes:

a first receiving module, configured to receive a file of an encrypted application;

a second decryption module, configured to decrypt the file of the encrypted application to obtain and run a decrypted application; and

a third decryption module, configured to decrypt encrypted control data according to the decrypted application.

In some embodiments, the third decryption module includes:

a first receiving unit, configured to receive the encrypted control data from a control module; and

a third decryption unit, configured to decrypt the encrypted control data according to the decrypted application, to obtain decrypted control data, where the decrypted application includes a decryption algorithm corresponding to the encrypted control data.

In some embodiments, after the third decryption unit obtains the decrypted control data, the third decryption module further includes:

a first sending unit, configured to send the decrypted control data to the control module.

In some embodiments, the encrypted control data is read by the control module from a storage module and then sent to the encryption module.

In some embodiments, the third decryption module includes:

a first running unit, configured to run the decrypted application to obtain a key; and

a second sending unit, configured to send the key to a control module so that the control module decrypts the encrypted control data according to the key.

In some embodiments, the file of the encrypted application is read by the control module from the storage module and then sent to the encryption module.

According to a fifth aspect of the embodiments of the present invention, an electronic device is provided, including: at least one processor; and a memory communicatively connected to the at least one processor, where the memory stores an instruction executable by the at least one processor, and the instruction is executed by the at least one processor, so that the at least one processor performs the foregoing data decryption method.

In the embodiments of the present invention, a file of an encrypted application and control data are obtained by a control module, then the file of the encrypted application is sent to an encryption module, and the encryption module decrypts the file of the encrypted application, to obtain decrypted control data. A control program is stored in the control module, while the control data is not stored in the control module, and the control data is decrypted in the encryption module. The difficulty and costs for decrypting data are improved because the three processes are separated. In addition, because the data is not decrypted in the control module, there will be no delay in the response and processing of other functions with high real-time requirements, thus ensuring smooth running of all functions.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of a data decryption system according to an embodiment of the present invention;

FIG. 2 is a diagram among a storage module 101, a control module 102, and an encryption module 103 according to an embodiment of the present invention;

FIG. 3 is a schematic structural diagram of another data decryption system according to an embodiment of the present invention;

FIG. 4 is a diagram of interaction among a storage module 201, a control module 202, and an encryption module 203 according to another embodiment of the present invention;

FIG. 5 is a schematic flowchart of a data decryption method according to an embodiment of the present invention;

FIG. 6 is a schematic flowchart of an implementation of a step of decrypting encrypted control data based on a decrypted application in a data decryption method according to an embodiment of the present invention;

FIG. 7 is a schematic flowchart of another implementation of a step of decrypting encrypted control data based on a decrypted application in a data decryption method according to an embodiment of the present invention;

FIG. 8 is a schematic structural diagram of a data decryption apparatus according to an embodiment of the present invention;

FIG. 9 is a schematic structural diagram of a data decryption apparatus according to another embodiment of the present invention; and

FIG. 10 is a schematic hardware structural diagram of an electronic device for performing a data decryption method according to an embodiment of the present invention.

### DETAILED DESCRIPTION

To make the objectives, technical solutions, and advantages of the present invention clearer and more comprehensible, the following further describes the present invention in detail with reference to the accompanying drawings and embodiments. It should be understood that the embodiments herein are provided for describing the present invention and are not intended to limit the present invention.

It is to be noted that, if there is no conflict, all characteristics in the embodiments of the present invention can be mutually combined, which are all under the protection scope of the present invention. In addition, functional modules are divided in a schematic diagram of an apparatus and a logic order is shown in a flowchart. However, steps showed or described may be performed in a manner different from the module division in the schematic diagram of the apparatus or the order shown in the flowchart.

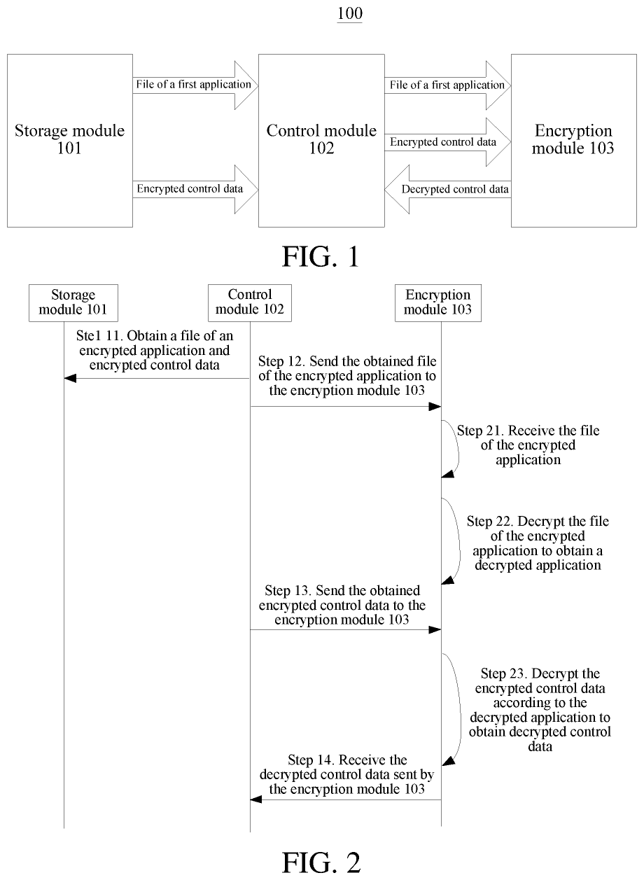

FIG. 1 is a schematic structural diagram of a data decryption system according to an embodiment of the present invention. As shown in FIG. 1, the system 100 includes a storage module 101, a control module 102, and an encryption module 103. The control module 102 is communicatively connected to the storage module 101 and the encryption module 103 respectively.

The storage module 101 is configured to store a file of an encrypted application and encrypted control data. The storage module 101 specifically may be a chip with a storage function, for example, a flash chip, or an SD card. In the prior art, control data of a device is generally stored in a storage module after being encrypted, and a control program is stored in a control module. When the control module 102 needs to run the control data, the encrypted control data is read from the storage module, and the encrypted control data is decrypted by using the control program. After decrypted control data is obtained, the control module loads and runs the control data. However, in the embodiments of the present invention, the file of the application and the control data are both stored in the storage module 101, so that there the device can complete a new modification on a data encryption and decryption algorithm without updating the program in the control module and the encrypted file in the storage module, thereby reducing the difficulty in updating and maintaining products subsequently.

The file of the application includes a decryption algorithm corresponding to the encrypted control data, and after the file of the application is decrypted, the encrypted control data can be decrypted by running the application. The control data is configured to enable the control module 102 to implement a control function. Different functions correspond to different pieces of control data, and different pieces of control data correspond to files of different applications.

The control module 102 specifically may be any chip with computing control and processing capabilities, for example, a controller or a processor. The control module 102 is configured to read the file of the encrypted application and the encrypted control data from the storage module 101, and send the two pieces of data to the encryption module 103.

The encryption module 103 specifically may be any high-security chip that can repeatedly load and run an application and has computing control and processing functions. The encryption module 103 is configured to receive the file of the encrypted application and the encrypted control data sent by the control module 102, and decrypt the two pieces of data respectively.

Specifically, FIG. 2 shows one of embodiments of a data decryption method run on the data decryption system according to the embodiment of the present invention shown in FIG. 1. The method includes:

Step 11. The control module 102 obtains a file of an encrypted application and encrypted control data.

Step 12. The control module 102 sends the obtained file of the encrypted application to the encryption module 103. The application is a program that implements encryption/decryption on control data, and the encrypted control data is decrypted by running the application.

Step 21. The encryption module 103 receives the file of the encrypted application.

Step 22. The encryption module 103 decrypts the file of the encrypted application to obtain a decrypted application.

Step 23. The encryption module 103 decrypts the encrypted control data according to the decrypted application to obtain decrypted control data.

In this embodiment, as shown in FIG. 2, implementation of the foregoing step 23 specifically includes:

Step 13. The control module 102 sends the obtained encrypted control data to the encryption module 103.

Step 231 (which is omitted). The encryption module 103 runs the decrypted application, to decrypt the encrypted control data, where the decrypted application includes a decryption algorithm corresponding to the encrypted control data.

Step 14. The control module 102 receives decrypted control data sent by the encryption module 103.

According to the foregoing data decryption method, the control module 102 sends a file of an encrypted application and encrypted control data to the encryption module 103. Then, the file of the encrypted application is decrypted in the encryption module 103, and the encrypted control data is decrypted by using the decrypted application. Finally, decrypted control data is sent to the control module 102. This implementation can decrypt the encrypted control data safely and efficiently.

It is to be noted that, decryption of the encrypted control data is not limited to the foregoing implementation, and the encrypted control data can also be decrypted in other manners.

The embodiments of the present invention provide a data decryption system. According to the system, a control module reads a file of an encrypted application and encrypted control data from a storage module, and then sends the file of the application to an encryption module. The encryption module decrypts the file of the application and runs the application to decrypt the control data, so that the control module performs control processing by using decrypted control data. A control program is stored in the control module, while the control data is not stored in the control module, and the control data is decrypted in the encryption module. The difficulty and costs for decrypting data are improved because the three processes are separated. In addition, because the data is not decrypted in the control module, there will be no delay in the response and processing of other functions with high real-time requirements, thus ensuring smooth running of all functions.

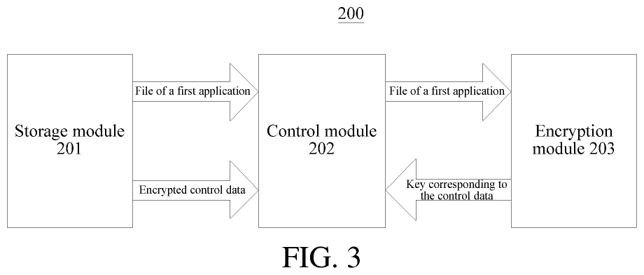

FIG. 3 is a schematic structural diagram of another data decryption system according to an embodiment of the present invention. As shown in FIG. 3, the system 200 includes a storage module 201, a control module 202, and an encryption module 203. The control module 202 is communicatively connected to the storage module 201 and the encryption module 203 respectively.

The storage module 201 is configured to store a file of an encrypted application and encrypted control data. The storage module 201 specifically may be a chip with a storage function, for example, a flash chip or an SD card. The file of the application includes a decryption algorithm, and after the file of the application is decrypted, the encrypted control data can be decrypted by using the application. The control data is configured to enable the control module 202 to implement a control function. Different functions correspond to different pieces of control data, and different pieces of control data correspond to files of different applications.

The control module 202 specifically may be any chip with computing control and processing capabilities, for example, a controller or a processor. The control module 202 is configured to read the file of the encrypted application and the encrypted control data from the storage module 201, and send the file of the encrypted application to the encryption module 203.

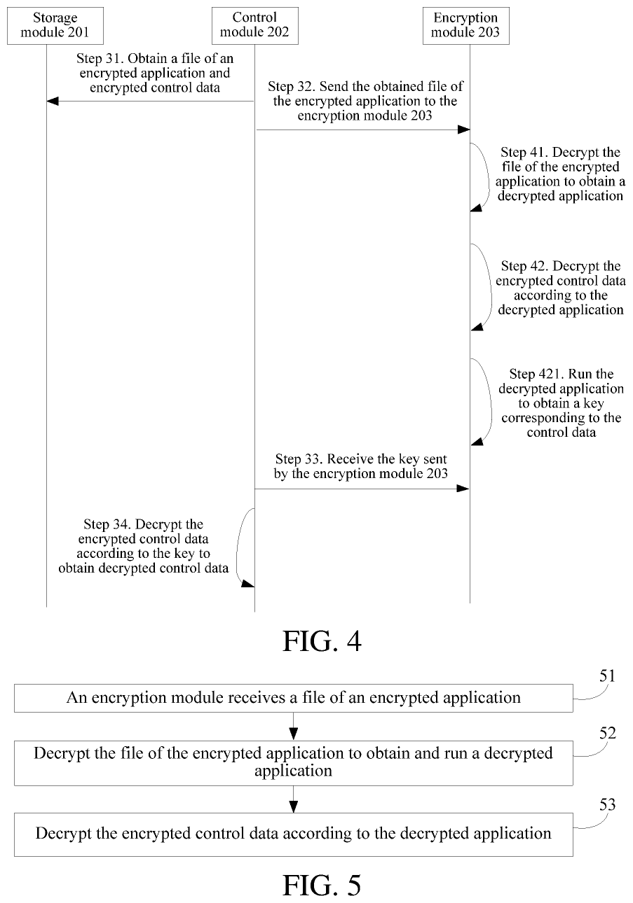

The encryption module 203 specifically may be any high-security chip that can repeatedly load and run an application and has computing control and processing functions. The encryption module 203 is configured to receive the file of the encrypted application sent by the control module 202, and decrypt the file of the application and run the application to obtain a key corresponding to the control data, and then send the key to the control module 202. Specifically, FIG. 4 shows another embodiment of a data decryption method run on the data decryption system according to the embodiment of the present invention shown in FIG. 3. The method includes:

Step 31. The control module 202 obtains a file of an encrypted application and encrypted control data from the storage module 201.

Step 32. The control module 202 sends the obtained file of the encrypted application to the encryption module 203.

Step 41. The encryption module 203 decrypts the file of the encrypted application to obtain a decrypted application.

Step 42. The encryption module 203 decrypts the encrypted control data according to the decrypted application.

In this embodiment, as shown in FIG. 4, implementation of the foregoing step 42 specifically includes:

Step 421. Run the decrypted application by using the encryption module 203 to obtain a key corresponding to the control data.

Step 33. The control module 202 receives the key sent by the encryption module 203.

Step 34. The control module 202 decrypts the encrypted control data according to the key to obtain decrypted control data.

According to the foregoing data decryption method, the control module 202 sends a file of an encrypted application to the encryption module 203. The encryption module 203 runs a decrypted application to obtain a key corresponding to encrypted control data, and then sends the key back to the control module 202, so that the encrypted control data is decrypted in the control module 202 through the key. This implementation can decrypt the encrypted control data safely and efficiently.

It is to be noted that, decryption of the encrypted control data is not limited to the foregoing implementation, and the encrypted control data can also be decrypted in other manners.

The embodiments of the present invention provide a data decryption system. According to the system, a control module reads a file of an encrypted application and encrypted control data from a storage module, then sends the file of the application to an encryption module. The encryption module decrypts the file of the encrypted application and runs the application to obtain a key corresponding to the control data. The encryption module sends the key to the control module to enable the control module to decrypt the control data through the key. A control program is stored in the control module, the control data is stored in the storage module, and the key of the control data is obtained in the encryption module. The difficulty and costs for decrypting data are improved because the three processes are separated, thereby improving data security.

FIG. 5 is a schematic flowchart of a data decryption method according to an embodiment of the present invention. The method is applied to the encryption module shown in the foregoing embodiments. As shown in FIG. 5, the method includes:

Step 51. The encryption module receives a file of an encrypted application, where the file of the encrypted application is read by a control module from a storage module and then sent to the encryption module.

Step 52. Decrypt the file of the encrypted application to obtain and run a decrypted application.

Step 53. Decrypt the encrypted control data according to the decrypted application.

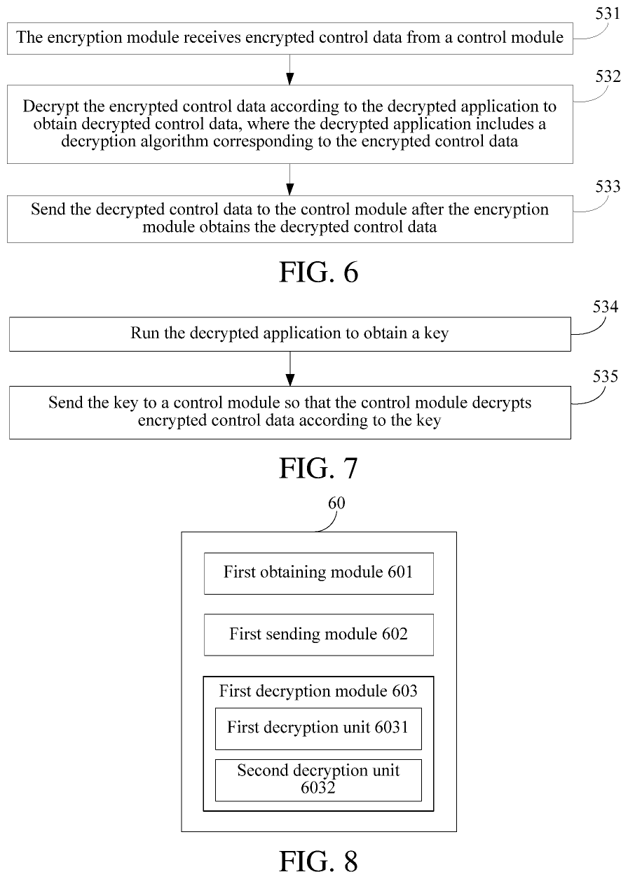

As shown in FIG. 6, in one of implementations, the decrypting the encrypted control data according to the decrypted application includes:

Step 531. The encryption module receives the encrypted control data from the control module.

Step 532. Decrypt the encrypted control data according to the decrypted application to obtain decrypted control data, where the decrypted application includes a decryption algorithm corresponding to the encrypted control data.

Step 533. Send the decrypted control data to the control module after the encryption module obtains the decrypted control data.

The encrypted control data is read by the control module from a storage module and then sent to the encryption module.

According to the foregoing implementations, the encryption module obtains a file of an encrypted application and encrypted control data. The file of the encrypted application is decrypted in the encryption module. A decrypted application is obtained and run, to decrypt encrypted control data through the decrypted application. Finally, decrypted control data is sent to the control module.

It is to be noted that, in addition to the forgoing manners, the encrypted control data can also be decrypted in other manners. For example, as shown in FIG. 7, in another implementation, the decrypting the encrypted control data according to the decrypted application includes:

Step 534. Run the decrypted application to obtain a key.

Step 535. Send the key to a control module so that the control module decrypts the encrypted control data according to the key.

According to the foregoing implementations, the encryption module obtains the key by running the decrypted application, so that the encrypted control data is decrypted through the key.

The embodiments of the present invention provide a data decryption method. According to the method, a file of an encrypted application is obtained; then, the file of the encrypted application is decrypted to obtain a decrypted application, and encrypted control data is decrypted by running the application. The encrypted control data can be decrypted through the decrypted application, or the encrypted control data can be decrypted through a key corresponding to the encrypted control data after the key is obtained through the decrypted application. This implementation not only can decrypt the encrypted control data effectively, but also can ensure data security.

FIG. 8 is a schematic structural diagram of a data decryption apparatus according to an embodiment of the present invention. The apparatus 60 includes: a first obtaining module 601, a first sending module 602, and a first decryption module 603.

The first obtaining module 601 is configured to obtain a file of an encrypted application and encrypted control data; the first sending module 602 is configured to send the obtained file of the encrypted application to an encryption module; and the first decryption module 603 is configured to decrypt the encrypted control data by using the encryption module to obtain decrypted control data.

In this embodiment, the first obtaining module 601 is specifically configured to obtain the file of the encrypted application and the encrypted control data from a storage module, where the first obtaining module obtains, according to a current to-be-executed control function, a file of an encrypted application and encrypted control data corresponding to the control function.

The first decryption module 603 includes a first decryption unit 6031 and a second decryption unit 6032. The first decryption unit 6031 is configured to decrypt the file of the encrypted application by using the encryption module to obtain a decrypted application; the second decryption unit 6032 is configured to decrypt the encrypted control data according to the decrypted application to obtain the decrypted control data.

The obtaining decrypted control data includes: receiving the decrypted control data sent by the encryption module.

The second decryption unit 6031 is specifically configured to: send the obtained encrypted control data to the encryption module; and run the decrypted application by using the encryption module, to decrypt the encrypted control data, where the decrypted application includes a decryption algorithm corresponding to the encrypted control data.

In some other embodiments, the second decryption unit 6031 is specifically configured to: run the decrypted application by using the encryption module to obtain a key corresponding to the control data; receive the key sent by the encryption module; and decrypt the encrypted control data according to the key.

It is to be noted that, content such as information interaction and an execution process in each unit in the data decryption apparatus according to the embodiments of the present invention and the methods and steps shown in FIG. 2 and FIG. 4 are based on a same conception. Therefore, the specific content is also applicable to the data decryption apparatus. Each unit according to the embodiments of the present invention can be implemented as independent hardware or software, and functions of the units can be combined by using independent hardware or software according to requirements.

The embodiments of the present invention provide a data decryption apparatus. According to the apparatus, a file of an encrypted application and encrypted control data are read from a storage module, then the file of the encrypted application is sent to an encryption module. The encryption module decrypts the file of the encrypted application and runs the application to decrypt the encrypted control data, so that the control module performs control processing by using decrypted control data. A control program is stored in the control module, the control data is stored in a storage module, and the control data is decrypted in the encryption module. The difficulty and costs for decrypting data are improved because the three processes are separated. In addition, because the data is not decrypted in the control module, there will be no delay in the response and processing of other functions with high real-time requirements, thus ensuring smooth running of all functions.

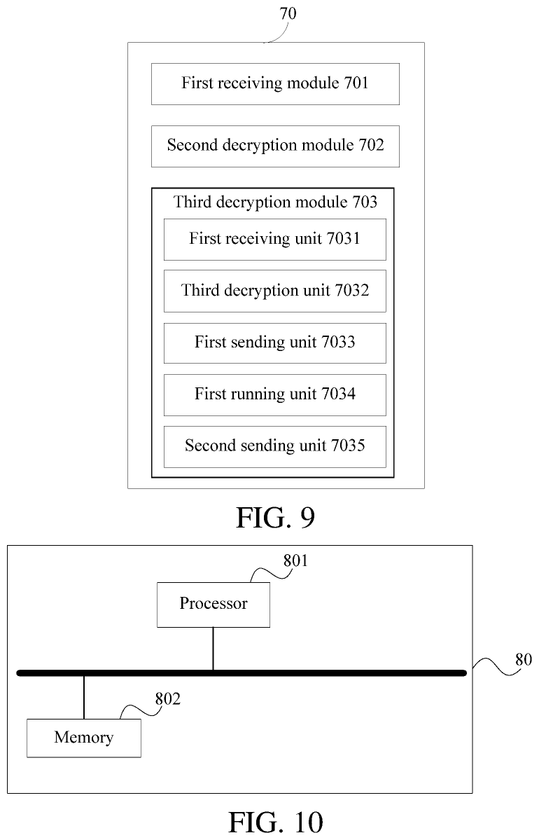

FIG. 9 is a schematic structural diagram of a data decryption apparatus according to another embodiment of the present invention. The apparatus is applied to the encryption module shown in the foregoing embodiments. As shown in FIG. 9, the apparatus 70 includes a first receiving module 701, a second decryption module 702, and a third decryption module 703.

The first receiving module 701 is configured to receive a file of an encrypted application; the second decryption module 702 is configured to decrypt the file of the encrypted application to obtain a decrypted application; and the third decryption module 703 is configured to decrypt the encrypted control data according to the decrypted application.

The file of the encrypted application is read by the control module from a storage module and then sent to the encryption module.

The third decryption module 703 includes a first receiving unit 7031 and a third decryption unit 7032. The first receiving unit 7031 is configured to receive the encrypted control data from a control module; the third decryption unit 7032 is configured to decrypt the encrypted control data according to the decrypted application, to obtain decrypted control data, where the decrypted application includes a decryption algorithm corresponding to the encrypted control data.

After the third decryption unit 7032 obtains the decrypted control data, the third decryption module 703 further includes a first sending unit 7033. The first sending unit 7033 is configured to send the decrypted control data to the control module.

The encrypted control data is read by the control module from a storage module and then sent to the encryption module.

In some other embodiments, referring to FIG. 9 again, the third decryption module 703 includes a first running unit 7034 and a second sending unit 7035. The first running unit 7034 is configured to run the decrypted application to obtain a key; the second sending unit 7035 is configured to send the key to a control module so that the control module decrypts the encrypted control data according to the key.

It is to be noted that, content such information interaction and an execution process in each unit in the data decryption apparatus according to the embodiments of the present invention and the methods and steps shown in FIG. 5, FIG. 6, and FIG. 7 are based on a same conception. Therefore, the specific content is also applicable to the data decryption apparatus.

Each unit according to the embodiments of the present invention can be implemented as independent hardware or software, and functions of the units can be combined by using independent hardware or software according to requirements.

The embodiments of the present invention provide a data decryption apparatus. According to the apparatus, a file of an encrypted application sent by a control module is received, and the file of the encrypted application is decrypted and the application is run, to decrypt encrypted control data. The encrypted control data can be decrypted through the decrypted application, or the encrypted control data can be decrypted through a key corresponding to the encrypted control data after the key is obtained through the decrypted application. This implementation not only can decrypt the encrypted control data effectively, but also can ensure data security.

FIG. 10 is a schematic hardware structural diagram of an electronic device for performing a data decryption method according to an embodiment of the present invention. As shown in FIG. 10, the electronic device 80 includes:

one or more processors 801 and a memory 802, where one processor 801 is taken as an example in FIG. 10.

The processor 801 and the memory 802 may be connected by using a bus or in other manners. In FIG. 10, as an example, connection is performed by using a bus.

As a non-volatile computer readable storage medium, the memory 802 can be configured to store a non-volatile software program, a non-volatile computer executable program and a module, for example, a program instruction/unit corresponding to the data decryption method according to the embodiments of the present invention (for example, the modules and units shown in FIG. 8 and FIG. 9). The processor 801 runs the non-volatile software program, instruction, and module stored in the memory 802, to perform various functional applications and data processing, that is, to implement the foregoing data decryption method.

The memory 802 may include a program storage area and a data storage area. The program storage area may store an operating system, and an application required by at least one function. The data storage area may store data created according to use of the data decryption apparatus, and the like. In addition, the memory 802 may include a high speed random access memory, and may also include a non-volatile memory, such as at least one magnetic disk storage device, a flash memory, or another non-volatile solid-state storage device. In some embodiments, the memory 802 may optionally include memories remotely disposed relative to the processor 801, and these remote memories may be connected to the data decryption apparatus through a network. Instances of the network include, but are not limited to, the Internet, an intranet, a local area network, a mobile communications network, and a combination thereof.

The one or more modules are stored in the memory 802, and when the one or more modules are executed by the one or more processors 801, the data decryption method according to any foregoing method embodiment is performed. For example, the method steps shown in the foregoing FIG. 2, FIG. 4, FIG. 5, FIG. 6, and FIG. 7 are performed, and the functions of the modules and units shown in FIG. 8 and FIG. 9 are implemented.

The foregoing product can implement the methods provided in the embodiments of the present invention, and have corresponding functional modules for performing the methods and beneficial effects. For technical details not described in detail in this embodiment, reference may be made to the methods provided in the embodiments of the present invention.

The electronic device of the embodiment of the present invention exists in a variety of forms, including but not limited to:

(1) a chip or module with computing control and processing functions, and the like.

(2) a high-security chip or module that can repeatedly load and run applications and has computing control and processing functions, and the like.

(3) other electronic apparatuses with a data interaction function.

The embodiments of the present invention provide a non-volatile computer readable storage medium. The non-volatile computer readable storage medium stores a computer executable instruction, and the computer executable instruction is executed by the electronic device to implement the data decryption method according to any of the foregoing method embodiments. For example, the method steps shown in the foregoing FIG. 2, FIG. 4, FIG. 5, FIG. 6, and FIG. 7 are performed, and the functions of the modules and units shown in FIG. 8 and FIG. 9 are implemented.

The embodiments of the present invention provide a computer program product, including a computer program stored on in a non-volatile computer readable storage medium. The computer program includes a program instruction. When the program instruction is executed by a computer, the computer implements the data decryption method according to any of the foregoing method embodiments. For example, the method steps shown in the foregoing FIG. 2, FIG. 4, FIG. 5, FIG. 6, and FIG. 7 are performed, and the functions of the modules and units shown in FIG. 8 and FIG. 9 are implemented.

The apparatus embodiments described above are merely schematic. The units described as separate parts may be or may not be physically apart. The parts displayed as units may be or may not be physical units. In other words, the units may be located at a same place, or may be distributed on a plurality of network units. Some or all modules may be selected based on an actual requirement, to achieve an objective of the solution in this embodiment.

Through the description of the foregoing implementations, a person skilled in the art may clearly understand that the implementations may be implemented by software in combination with a universal hardware platform, and may certainly be implemented by hardware. A person of ordinary skill in the art may understand that all or some of the procedures of the methods of the foregoing embodiments may be implemented by a computer program instructing relevant hardware. The program may be stored in a computer readable storage medium. When the program is executed, the program may include the procedures of the embodiments of the foregoing methods. The foregoing storage medium may include a magnetic disc, an optical disc, a read-only memory (ROM), a random access memory (RAM), or the like.

Finally, it should be noted that the foregoing embodiments are merely intended for describing the technical solutions of the present invention, but not for limiting the present invention. Under the conception of the present invention, the foregoing embodiments or the technical characteristics in different embodiments may be combined, the steps may be implemented in any order, and there are many other variations in different aspects of the present invention as described above, which are not provided in detail for simplicity. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A data decryption method, wherein the method comprises:
obtaining, by a control module, a file of an encrypted application and encrypted control data;
sending the obtained file of the encrypted application to an encryption module; and
decrypting the encrypted control data by using the encryption module to obtain decrypted control data.

2. The method according to claim 1, wherein the decrypting the encrypted control data by using the encryption module comprises:
decrypting the file of the encrypted application by using the encryption module to obtain a decrypted application; and
decrypting the encrypted control data according to the decrypted application.

3. The method according to claim 2, wherein the decrypting the encrypted control data according to the decrypted application comprises:
sending, by the control module, the obtained encrypted control data to the encryption module; and
running the decrypted application by using the encryption module, to decrypt the encrypted control data, wherein the decrypted application comprises a decryption algorithm corresponding to the encrypted control data.

4. The method according to claim 3, wherein the obtaining decrypted control data comprises: receiving, by the control module, the decrypted control data sent by the encryption module.

5. The method according to claim 2, wherein the decrypting the encrypted control data according to the decrypted application comprises:
running the decrypted application by using the encryption module to obtain a key corresponding to the control data;
receiving, by the control module, the key sent by the encryption module; and
decrypting, by the control module, the encrypted control data according to the key.

6. The method according to claim 1, wherein the obtaining a file of an encrypted application and encrypted control data specifically comprises:
obtaining, by the control module, the file of the encrypted application and the encrypted control data from a storage module, wherein the control module obtains, according to a current to-be-executed control function, a file of an encrypted application and encrypted control data corresponding to the control function.

7. A data decryption method applied to an encryption module, wherein the method comprises:
receiving, by the encryption module, a file of an encrypted application;
decrypting the file of the encrypted application to obtain and run a decrypted application; and
decrypting encrypted control data according to the decrypted application to obtain decrypted control data.

8. The method according to claim 7, wherein the decrypting encrypted control data according to the decrypted application to obtain decrypted control data comprises:
receiving, by the encryption module, the encrypted control data from a control module; and
decrypting the encrypted control data according to the decrypted application to obtain the decrypted control data, wherein the decrypted application comprises a decryption algorithm corresponding to the encrypted control data.

9. The method according to claim 8, wherein after the encryption module obtains the decrypted control data, the method further comprises: sending the decrypted control data to the control module.

10. The method according to claim 8, wherein the encrypted control data is read by the control module from a storage module and then sent to the encryption module.

11. The method according to claim 7, wherein the decrypting encrypted control data according to the decrypted application to obtain decrypted control data comprises:
running the decrypted application to obtain a key; and
sending the key to a control module, so that the control module decrypts the encrypted control data according to the key.

12. The method according to claim 7, wherein the file of the encrypted application is read by the control module from the storage module and then sent to the encryption module.

13. An electronic device, comprising: at least one processor; and a memory communicatively connected to the at least one processor, wherein the memory stores an instruction executable by the at least one processor, and the instruction is executed by the at least one processor, so that the at least one processor performs the method according to claim 1.
